(19) United States
(12) Patent Application Publication
(10) Pub. No.: US 2015/0103162 A1
(43) Pub. Date: Apr. 16, 2015

(54) SYSTEM OF QUICKLY GENERATING A RELATIONSHIP TABLE OF DISTANCE TO DISPARITY OF A CAMERA AND RELATED METHOD THEREOF

(71) Applicant: Etron Technology, Inc., Hsinchu (TW)

(72) Inventor: Chi-Feng Lee, Hsinchu County (TW)

(21) Appl. No.: 14/513,226

(22) Filed: Oct. 14, 2014

Related U.S. Application Data
(60) Provisional application No. 61/890,322, filed on Oct. 14, 2013.

(30) Foreign Application Priority Data
Oct. 9, 2014 (TW) 103135289

(51) Int. Cl. G01B 11/14; H04N 7/18

(52) U.S. Cl. CPC G01B 11/14; H04N 7/18
USPC 348/135

(57) ABSTRACT

A method of quickly generating a relationship table of distance to disparity of a camera includes a display displaying a plurality of predetermined pattern groups generated by a host, wherein each predetermined pattern group of the plurality of predetermined pattern groups corresponds to a predetermined distance, at least two image capture units included in the camera executing a disparity generation step on the each predetermined pattern group, and after the at least two image capture units execute the image capture step on the plurality of predetermined pattern groups, the host generating the relationship table according to a plurality of predetermined distances and disparities corresponding to the plurality of predetermined distances.

### CROSS REFERENCE TO RELATED APPLICATIONS

This application claims the benefit of U.S. Provisional Application No. 61/890,322, filed on Oct. 14, 2013 and entitled “Method of getting disparity to distance formula automatically,” the contents of which are incorporated herein by reference.

### BACKGROUND OF THE INVENTION

1. Field of the Invention

The present invention relates to a system of quickly generating a relationship table of distance to disparity of a camera and a related method thereof, and particularly to a system of quickly generating a relationship table of distance to disparity of a camera and a related method thereof that can utilize a host to generate a plurality of predetermined pattern groups corresponding to different predetermined distances to a display to quickly generate the relationship table of distance to disparity of the camera.

2. Description of the Prior Art

Currently, a method of generating a relationship table of distance to disparity of a camera utilizes the camera to capture a plurality of images corresponding to a plurality of objects corresponding to a plurality of different distances, and then a host coupled to the camera generates disparities corresponding to the plurality of different distances according to the plurality of images. After the host generates the disparities corresponding to the plurality of different distances, the host can generate the relationship table of distance to disparity of the camera according to the disparities corresponding to the plurality of different distances and the plurality of different distances.

However, the prior art has disadvantages as follows: first, an environment for generating the relationship table of distance to disparity of the camera is different from an environment for calibrating the camera, so the prior art has higher operation cost; and second, because the prior art needs to place the plurality of objects corresponding to the plurality of different distances, the prior art needs larger space. Therefore, the prior art is not a good choice for generating the relationship table of distance to disparity of the camera.

### SUMMARY OF THE INVENTION

An embodiment provides a method of quickly generating a relationship table of distance to disparity of a camera, wherein a system applied to the method includes a camera, a host, and a display, and the camera includes at least two image capture units. The method includes the display displaying a plurality of predetermined pattern groups generated by the host, wherein each predetermined pattern group of the plurality of predetermined pattern groups corresponds to a predetermined distance; the at least two image capture units executing a disparity generation step on the each predetermined pattern group, wherein the disparity generation step includes each image capture unit of the at least two image capture units executing an image capture operation on a corresponding exclusive predetermined pattern of the each predetermined pattern group to generate an image; and the host generating a disparity corresponding to the predetermined distance according to al least two images generated by the at least two image capture units; and the host generating the relationship table according to a plurality of predetermined distances and disparities corresponding to the plurality of predetermined distances after the at least two image capture units execute the image capture step on the plurality of predetermined pattern groups.

Another embodiment provides a system of quickly generating a relationship table of distance to disparity of a camera. The system includes a camera, a host, and a display. The camera includes at least two image capture units. The host is used for generating a plurality of predetermined pattern groups, wherein each predetermined pattern group of the plurality of predetermined pattern groups corresponds to a predetermined distance. The display is used for displaying the plurality of predetermined pattern groups. When the display displays the each predetermined pattern group, each image capture unit of the at least two image capture units executes an image capture operation on a corresponding exclusive predetermined pattern of the each predetermined pattern group to generate an image, the host further generates a disparity corresponding to the predetermined distance according to al least two images generated by the at least two image capture units, and after the at least two image capture units execute the image capture step on the plurality of predetermined pattern groups, the host, the host further generates the relationship table according to a plurality of predetermined distances and disparities corresponding to the plurality of predetermined distances.

The present invention provides a system of quickly generating a relationship table of distance to disparity of a camera and a related method thereof. The system and the method utilize a host to generate a plurality of predetermined pattern groups corresponding to different predetermined distances to a display, and utilize at least two image capture units of the camera to execute a disparity generation step on each predetermined pattern group of the plurality of predetermined pattern groups. After the at least two image capture units of the camera execute the disparity generation step on the plurality of predetermined pattern groups, the host can generate the relationship table according to disparities corresponding to a plurality of predetermined distances and the plurality of predetermined distances. Therefore, compared to the prior art, the present invention has advantages as follows: first, because the present invention utilizes the host to generate the plurality of predetermined pattern groups corresponding to the different predetermined distances to the display, the present invention does not need large space; and second, an environment applied to the present invention for generating the relationship table of distance to disparity of the camera is the same as an environment for calibrating the camera, the present invention has lower operation cost.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a system of quickly generating a relationship table of distance to disparity of a camera according to a first embodiment,

FIG. 2 is a flowchart illustrating a method of quickly generating a relationship table of distance to disparity of a camera according to a second embodiment.

FIGS. 3-5 are diagrams illustrating the predetermined pattern group corresponding to the predetermined distance.

FIG. 6 is a diagram illustrating the display displaying the predetermined pattern group according to a time division multiplexing method.

FIGS. 7, 8 are diagrams illustrating the display simultaneously displaying each predetermined pattern of the predetermined pattern group.

FIG. 9 is a diagram illustrating the host generating the disparity corresponding to the predetermined distance.

FIG. 10 is a diagram illustrating the host searching a plurality of feature points.

### DETAILED DESCRIPTION

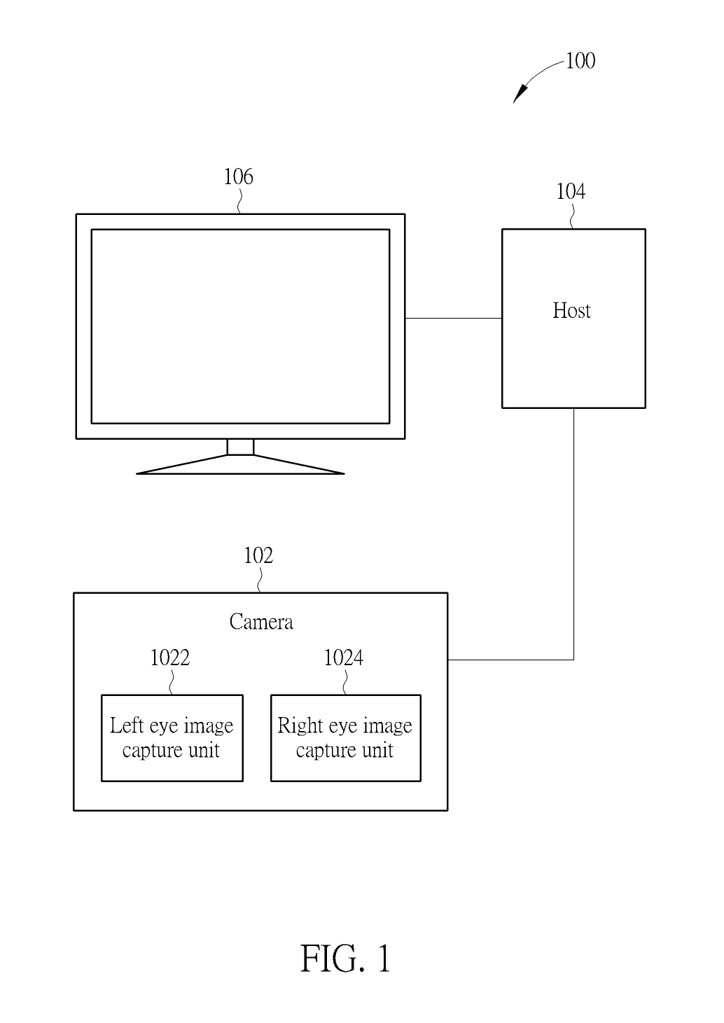

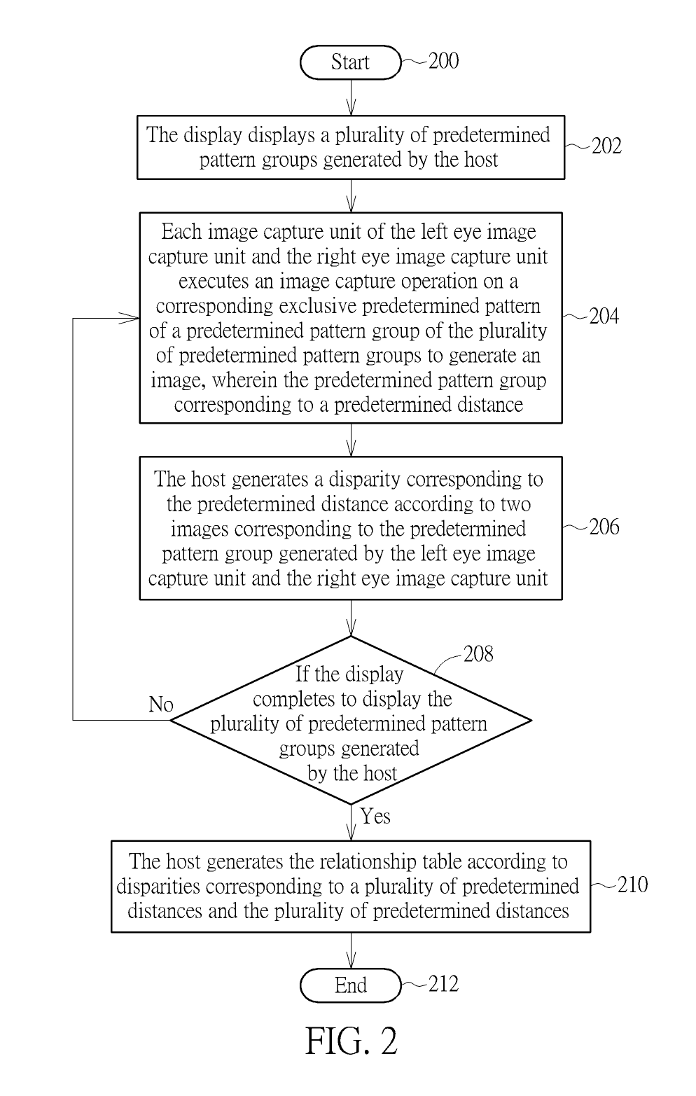

Please refer to FIG. 1. FIG. 1 is a diagram illustrating a system 100 of quickly generating a relationship table of distance to disparity of a camera according to a first embodiment, wherein the system 100 includes a camera 102, a host 104, and a display 106, and the camera 102 includes a left eye image capture unit 1022 and a right eye image capture unit 1024. But, the present invention is not limited to the camera 102 only including the left eye image capture unit 1022 and the right eye image capture unit 1024, that is, the camera 102 can include at least two image capture units. Please refer to FIGS. 1, 2. FIG. 2 is a flowchart illustrating a method of quickly generating a relationship table of distance to disparity of a camera according to a second embodiment. The method in FIG. 2 is illustrated using the system 100 in FIG. 1. Detailed steps are as follows:

Step 200: Start.

Step 202: The display 106 displays a plurality of predetermined pattern groups generated by the host 104.

Step 204: Each image capture unit of the left eye image capture unit 1022 and the right eye image capture unit 1024 executes an image capture operation on a corresponding exclusive predetermined pattern of a predetermined pattern group of the plurality of predetermined pattern groups to generate an image, wherein the predetermined pattern group corresponding to a predetermined distance.

Step 206: The host 104 generates a disparity corresponding to the predetermined distance according to two images corresponding to the predetermined pattern group generated by the left eye image capture unit 1022 and the right eye image capture unit 1024.

Step 208: If the display 106 completes to display the plurality of predetermined pattern groups generated by the host 104; if no, go to Step 204; if yes, go to Step 210.

Step 210: The host 104 generates the relationship table according to disparities corresponding to a plurality of predetermined distances and the plurality of predetermined distances.

Step 212: End.

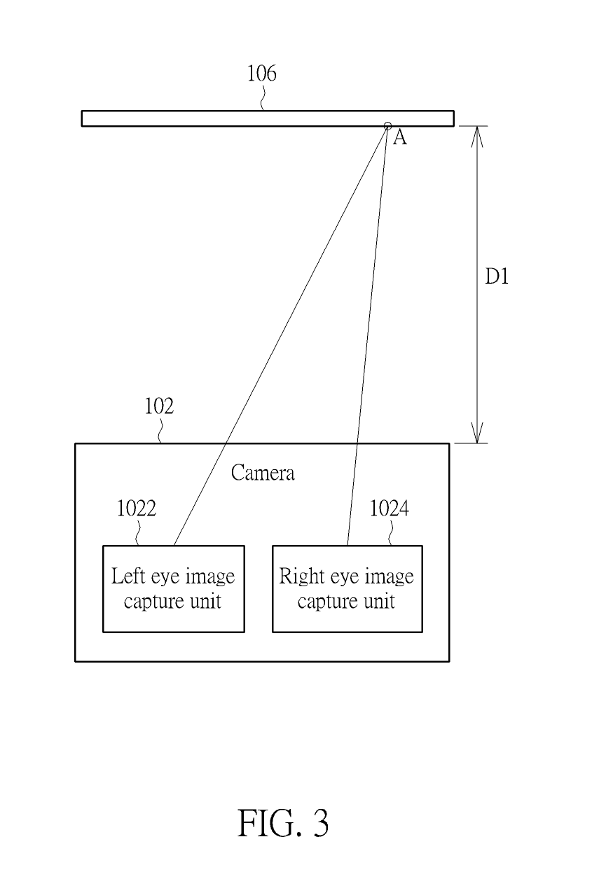

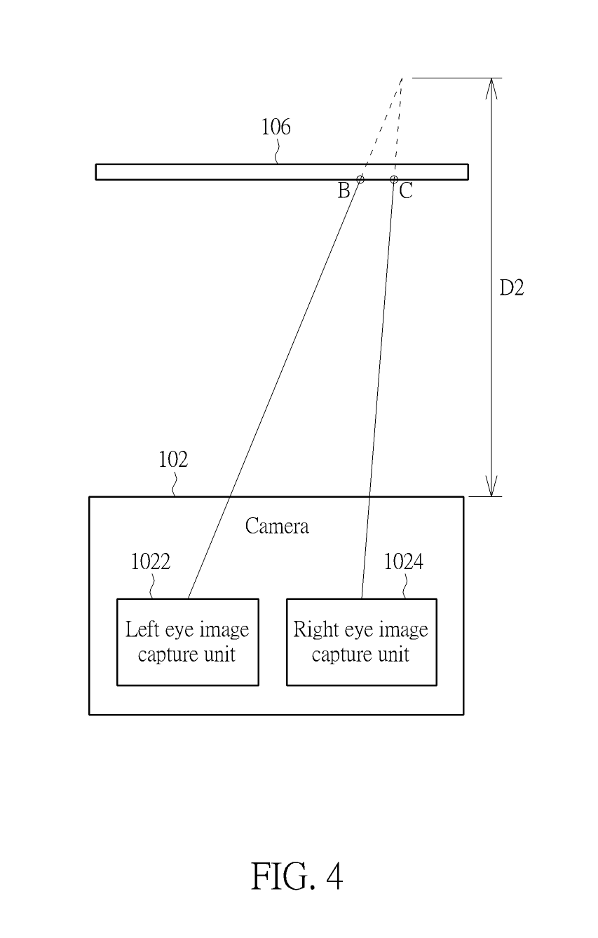

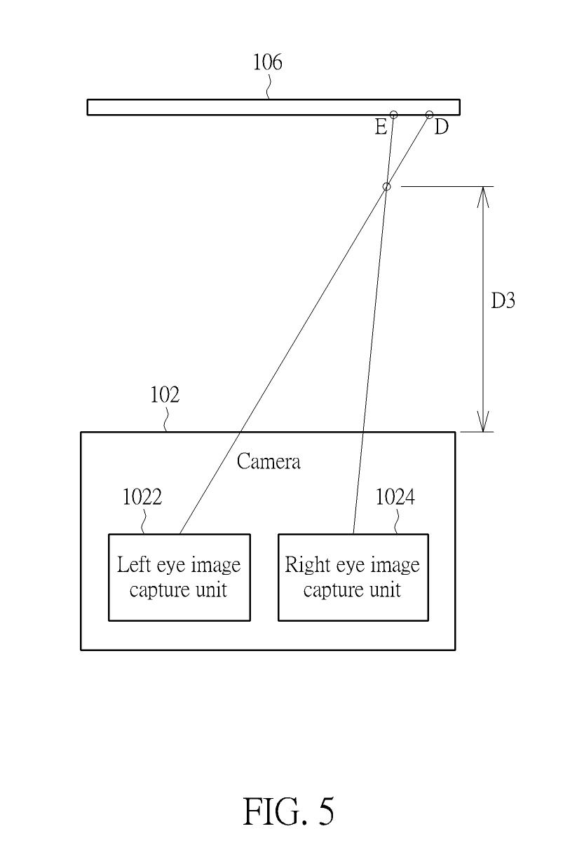

Please refer to FIGS. 3-5. FIGS. 3-5 are diagrams illustrating the predetermined pattern group corresponding to the predetermined distance. As shown in FIG. 3, when a position of each feature point of a predetermined pattern of the predetermined pattern group corresponding to the left eye image capture unit 1022 (e.g. a position of a feature point of the predetermined pattern corresponding to the left eye image capture unit 1022 is located at a point A of the display 106) is the same as a position of a corresponding feature point of a predetermined pattern of the predetermined pattern group corresponding to the right eye image capture unit 1024 (e.g. a position of a corresponding feature point of the predetermined pattern corresponding to the right eye image capture unit 1024 is also located at the point A of the display 106), the predetermined distance is D1, wherein the distance D1 is equal to a distance between the display 106 and the camera 102; as shown in FIG. 4, when the a position of each feature point of the predetermined pattern of the predetermined pattern group corresponding to the left eye image capture unit 1022 (e.g. a position of a feature point of the predetermined pattern corresponding to the left eye image capture unit 1022 is located at a point B of the display 106) is different from a position of a corresponding feature point of the predetermined pattern of the predetermined pattern group corresponding to the right eye image capture unit 1024 (e.g. a position of a corresponding feature point of the predetermined pattern corresponding to the right eye image capture unit 1024 is located at a point C of the display 106), the predetermined distance is D2, wherein the distance D2 is greater than the distance between the display 106 and the camera 102; and as shown in FIG. 5, when a position of each feature point of the predetermined pattern of the predetermined pattern group corresponding to the left eye image capture unit 1022 (e.g. a position of a feature point of the predetermined pattern corresponding to the left eye image capture unit 1022 is located at a point D of the display 106) is different from a position of a corresponding feature point of the predetermined pattern of the predetermined pattern group corresponding to the right eye image capture unit 1024 (e.g. a position of a corresponding feature point of the predetermined pattern corresponding to the right eye image capture unit 1024 is located at a point E of the display 106), the predetermined distance is D3, wherein the distance D3 is less than the distance between the display 106 and the camera 102. In addition, the predetermined pattern of the predetermined pattern group corresponding to the left eye image capture unit 1022 and the predetermined pattern of the predetermined pattern group corresponding to the right eye image capture unit 1024 are two-dimensional patterns, and the predetermined pattern of the predetermined pattern group corresponding to the left eye image capture unit 1022 corresponds to the predetermined pattern of the predetermined pattern group corresponding to the right eye image capture unit 1024 each other.

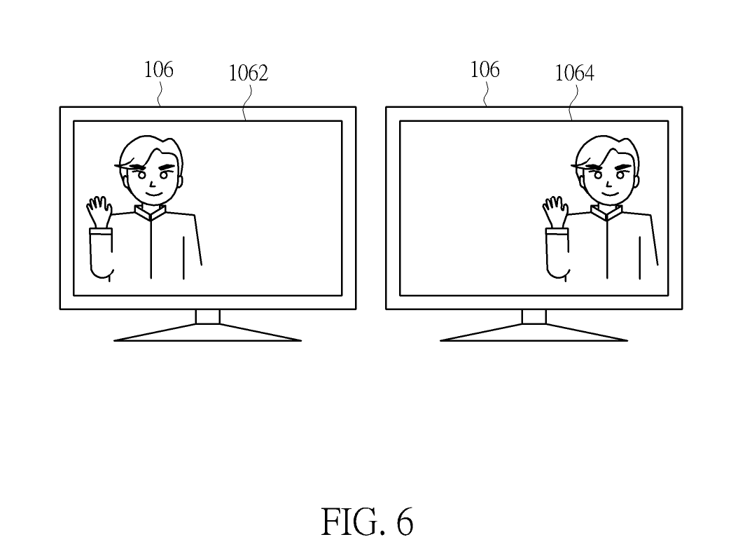

Please refer to FIG. 6. FIG. 6 is a diagram illustrating the display 106 displaying the predetermined pattern group according to a time division multiplexing method. As shown in FIG. 6, during a period T1, the display 106 displays a frame 1062 of the predetermined pattern corresponding to the left eye image capture unit 1022, and during a period T2 following the period T1, the display 106 displays a frame 1064 of the predetermined pattern corresponding to the right eye image capture unit 1024, wherein the host 104 can transmit a synchronization signal to the display 106 to make the display 106 display the predetermined pattern corresponding to the left eye image capture unit 1022 and the predetermined pattern corresponding to the right eye image capture unit 1024 in turn. In addition, in another embodiment of the present invention, because the host 104 can transmit the synchronization signal to the display 106, the display 106 can first display at least one predetermined pattern of the plurality of predetermined pattern groups corresponding to the left eye image capture unit 1022, and then display at least one predetermined pattern of the plurality of predetermined pattern groups corresponding to the right eye image capture unit 1024.

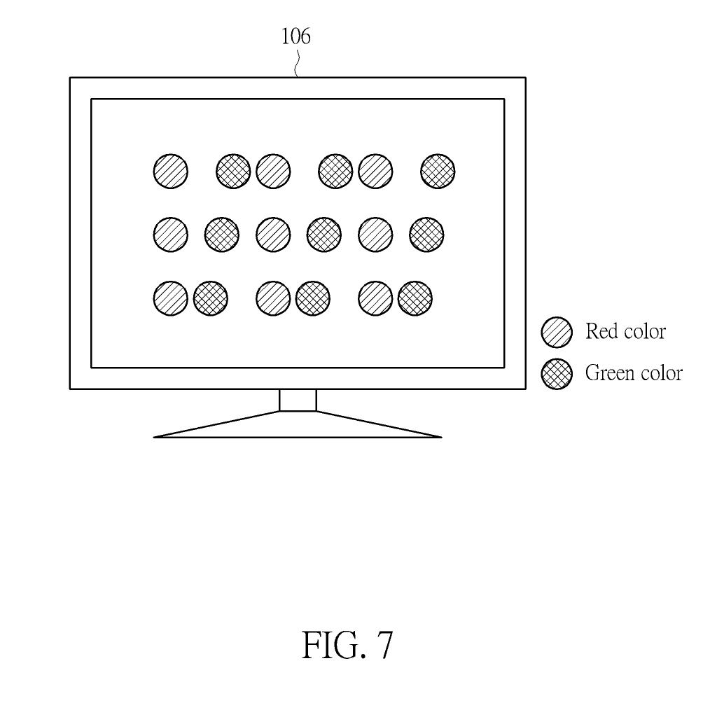

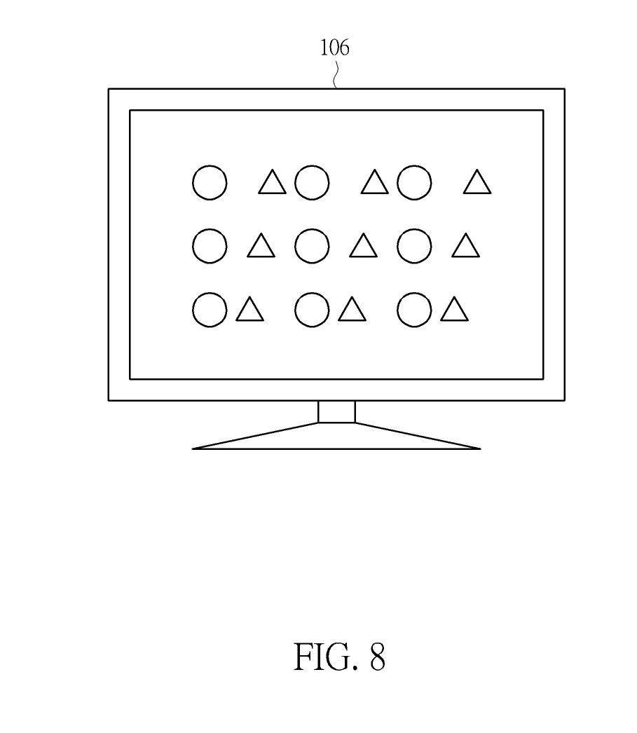

Please refer to FIGS. 7, 8. FIGS. 7, 8 are diagrams illustrating the display 106 simultaneously displaying each predetermined pattern of the predetermined pattern group. As shown in FIG. 7, the display 106 simultaneously displays the predetermined pattern corresponding to the left eye image capture unit 1022 and the predetermined pattern corresponding to the right eye image capture unit 1024, wherein each of the predetermined pattern corresponding to the left eye image capture unit 1022 and the predetermined pattern corresponding to the right eye image capture unit 1024 has a corresponding exclusive color. For example, the predetermined pattern corresponding to the left eye image capture unit 1022 corresponds to red color and the predetermined pattern corresponding to the right eye image capture unit 1024 corresponds to green color. That is to say, the left eye image capture unit 1022 can utilize a red color filter to filter the predetermined pattern corresponding to the right eye image capture unit 1024, and the right eye image capture unit 1024 can utilize a green color filter to filter the predetermined pattern corresponding to the left eye image capture unit 1022. But, the present invention is not limited to the left eye image capture unit 1022 utilizing the red color filter to filter the predetermined pattern corresponding to the right eye image capture unit 1024 and the right eye image capture unit 1024 utilizing the green color filter to filter the predetermined pattern corresponding to the left eye image capture unit 1022. As shown in FIG. 8, the display 106 simultaneously displaying the predetermined pattern corresponding to the left eye image capture unit 1022 and the predetermined pattern corresponding to the right eye image capture unit 1024, wherein each of the predetermined pattern corresponding to the left eye image capture unit 1022 and the predetermined pattern corresponding to the right eye image capture unit 1024 has a corresponding exclusive shape. For example, the predetermined pattern corresponding to the left eye image capture unit 1022 corresponds to circle form and the predetermined pattern corresponding to the right eye image capture unit 1024 corresponds to triangle form. That is to say, the left eye image capture unit 1022 can utilize a pattern recognition method to filter the predetermined pattern corresponding to the right eye image capture unit 1024 and the right eye image capture unit 1024 can also utilize the pattern recognition method to filter the predetermined pattern corresponding to the left eye image capture unit 1022. In addition, in another embodiment of the present invention, the display 106 can utilize a combination of FIGS. 6, 7, 8 to display the predetermined pattern group. In addition, the predetermined distance corresponding to the predetermined pattern group can be pre-stored in a storage device of the host 104. In addition, subsequent operational principles of other predetermined pattern groups of the plurality of predetermined pattern groups are the same as those of the predetermined pattern group, so further description thereof is omitted for simplicity.

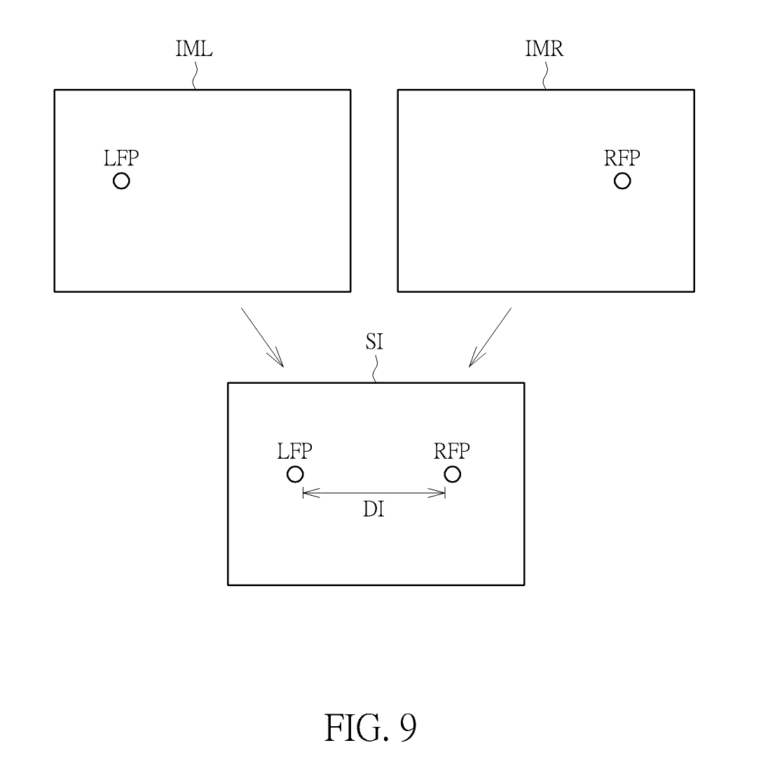

In Step 204, during the period T1, the left eye image capture unit 1022 can execute the image capture operation on the predetermined pattern corresponding to the left eye image capture unit 1022 displayed on the display 106 to generate an image IML (as shown in FIG. 9), wherein the image IML has a feature point LFP; and during the period T2 following the period T1, the right eye image capture unit 1024 can execute the image capture operation on the predetermined pattern corresponding to the right eye image capture unit 1024 displayed on the display 106 to generate an image IMR (as shown in FIG. 9), wherein image IMR has a feature point RFP. In addition, the image IML and the image IMR are only used for describing the present invention, that is, the present invention is not limited to the image IML and image IMR only having one feature point.

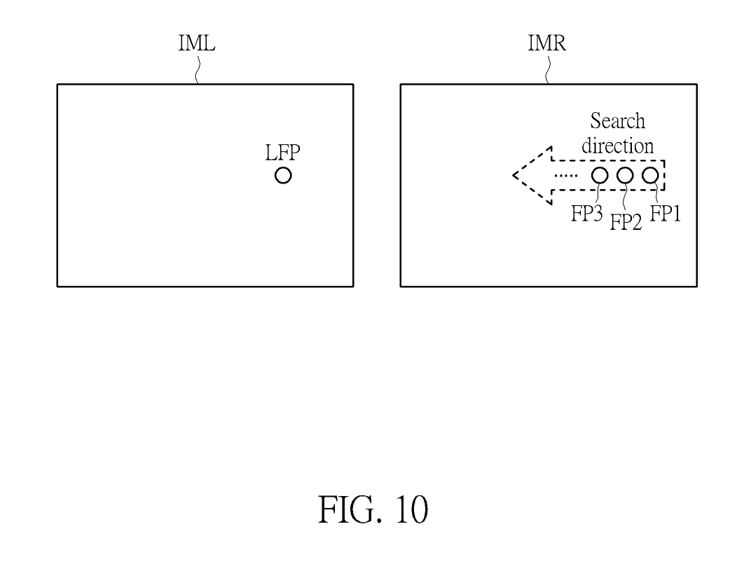

In Step 206, as shown in FIG. 9, the host 104 can generate a disparity DI corresponding to the predetermined distance according to the image IML and the image IMR. That is to say, the host 104 can superpose the image IML on the image IMR to generate a superposition image SI, and then the host 104 can calculate the disparity DI corresponding to the predetermined distance (that is, the disparity DI is equal to a distance between the feature point LFP and the feature point RFP in the superposition image SI) according to the superposition image SI. In addition, in another embodiment of the present invention, the host 104 executes a stereo matching method provided by the prior art on all pixels of the image IML and the image IMR to calculate the disparity corresponding to the predetermined distance. In addition, in another embodiment of the present invention, as shown in FIG. 10, the host 104 can first find the feature point LFP of the image IML, and then search the image IMR to find a plurality of points FP1, FP2, FP3, . . . , and then check which one has the highest relevance with the feature point LFP of the image IML. But, the present invention is not limited to a search direction executed by the host 104 in the image IMR shown in FIG. 10. Therefore, as shown in FIG. 10, the host 104 can calculate the disparity corresponding to the predetermined distance according to the feature point LFP of the image IML and one of the plurality of points FP1, FP2, FP3, . . . of the image IMR having the highest relevance with the feature point LFP. In addition, because the host 104 can utilize a method provided by the prior art to calculate the disparity corresponding to the predetermined distance according to the predetermined pattern corresponding to the left eye image capture unit 1022 and the predetermined pattern corresponding to the right eye image capture unit 1024 shown in FIGS. 7, 8, so further description thereof is omitted for simplicity.

In Step 210, after the host 104 generates the disparities corresponding to the plurality of predetermined distances according to the above mentioned method, the host 104 can utilize a formula, a look-up table, and other methods provided by the prior art to generate the relationship table according to the disparities corresponding to the plurality of predetermined distances and the plurality of predetermined distances. For example, the host 104 can utilize equation (1) to generate the relationship table:

PD=a+b/(DIS)⁻¹+c/(DIS)⁻² (1)

As shown in equation (1), PD represents a predetermined distance, and DIS represents a disparity. Therefore, the host 104 can utilize a regression method to calculate coefficients a, b, c in equation (1) according to the disparities corresponding to the plurality of predetermined distances generated by Step 210 and the plurality of predetermined distances. In addition, the present invention is not limited to the host 104 utilizing equation (1) to generate the relationship table. That is to say, the host 104 can also utilize other formulas to generate the relationship table. In addition, after the relationship table is generated, the host 104 can utilize a linear interpolation method to calculate a disparity corresponding to a distance according to the relationship table.

To sum up, the system of quickly generating a relationship table of distance to disparity of a camera and the related method thereof utilize the host to generate a plurality of predetermined pattern groups corresponding to different predetermined distances to the display, and utilize the at least two image capture units of the camera to execute a disparity generation step on each predetermined pattern group of the plurality of predetermined pattern groups. After the at least two image capture units of the camera execute the disparity generation step on the plurality of predetermined pattern groups, the host can generate the relationship table according to disparities corresponding to a plurality of predetermined distances and the plurality of predetermined distances. Therefore, compared to the prior art, the present invention has advantages as follows: first, because the present invention utilizes the host to generate the plurality of predetermined pattern groups corresponding to the different predetermined distances to the display, the present invention does not need large space; and second, an environment applied to the present invention for generating the relationship table of distance to disparity of the camera is the same as an environment for calibrating the camera, the present invention has lower operation cost.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of quickly generating a relationship table of distance to disparity of a camera, wherein a system applied to the method comprises a camera, a host, and a display, wherein the camera comprises at least two image capture units, the method comprising:
the display displaying a plurality of predetermined pattern groups generated by the host, wherein each predetermined pattern group of the plurality of predetermined pattern groups corresponds to a predetermined distance;
the at least two image capture units executing a disparity generation step on the each predetermined pattern group, wherein the disparity generation step comprises:
each image capture unit of the at least two image capture units executing an image capture operation on a corresponding exclusive predetermined pattern of the each predetermined pattern group to generate an image; and
the host generating a disparity corresponding to the predetermined distance according to al least two images generated by the at least two image capture units; and
the host generating the relationship table according to a plurality of predetermined distances and disparities corresponding to the plurality of predetermined distances after the at least two image capture units execute the image capture step on the plurality of predetermined pattern groups.

2. The method of claim 1, wherein the display displays each predetermined pattern of the each predetermined pattern group according to a time division multiplexing method.

3. The method of claim 1, wherein the display simultaneously displays each predetermined pattern of the each predetermined pattern group, and the corresponding exclusive predetermined pattern has a corresponding exclusive color.

4. The method of claim 1, wherein the display simultaneously displays each predetermined pattern of the each predetermined pattern group, and the corresponding exclusive predetermined pattern has a corresponding exclusive shape.

5. The method of claim 1, wherein each predetermined pattern of the each predetermined pattern group is a two-dimensional pattern.

6. The method of claim 1, wherein the predetermined distance is pre-stored in a storage device of the host.

7. The method of claim 1, wherein the host generates the disparity corresponding to the predetermined distance according to corresponding feature points of the al least two images generated by the at least two image capture units.

8. A system of quickly generating a relationship table of distance to disparity of a camera, comprising:
a camera comprising at least two image capture units;
a host generating a plurality of predetermined pattern groups, wherein each predetermined pattern group of the plurality of predetermined pattern groups corresponds to a predetermined distance; and
a display displaying the plurality of predetermined pattern groups;
wherein when the display displays the each predetermined pattern group, each image capture unit of the at least two image capture units executes an image capture operation on a corresponding exclusive predetermined pattern of the each predetermined pattern group to generate an image, the host further generates a disparity corresponding to the predetermined distance according to al least two images generated by the at least two image capture units, and after the at least two image capture units execute the image capture step on the plurality of predetermined pattern groups, the host further generates the relationship table according to a plurality of predetermined distances and disparities corresponding to the plurality of predetermined distances.

9. The system of claim 8, wherein the display displays each predetermined pattern of the each predetermined pattern group according to a time division multiplexing method.

10. The system of claim 8, wherein the display simultaneously displays each predetermined pattern of the each predetermined pattern group, and the corresponding exclusive predetermined pattern has a corresponding exclusive color.

11. The system of claim 8, wherein the display simultaneously displays each predetermined pattern of the each predetermined pattern group, and the corresponding exclusive predetermined pattern has a corresponding exclusive shape.

12. The system of claim 8, wherein each predetermined pattern of the each predetermined pattern group is a two-dimensional pattern.

13. The system of claim 8, wherein the predetermined distance is pre-stored in a storage device of the host.

14. The system of claim 8, wherein the host generates the disparity corresponding to the predetermined distance according to corresponding feature points of the al least two images generated by the at least two image capture units.
